(19) United States
(12) Patent Application Publication
(10) Pub. No.: US 2026/0367934 A1
(43) Pub. Date: Nov. 19, 2026

(54) Metadata-Based Detection of Changes in Underlying Forms for Updating Data Collection Interfaces

(71) Applicant: Oracle International Corporation, Redwood Shores, CA (US)

(72) Inventors: Allen Roshan D’Souza, Houston, TX (US); Venkata Narsimha Rao Gurrapu Srinivas, Hyderabad (IN); Veera Venkata Naga Raju Sripada, Cupertino, CA (US); Hephzibah Peruri, Hyderabad (IN); Bharat Suram, Hyderabad (IN); Robert Anthony Johnson, Melbourne, FL (US); Ankur Handa, Santa Clara, CA (US); Dipen Ashvinkumar Joshi, Katy, TX (US)

(73) Assignee: Oracle International Corporation, Redwood Shores, CA (US)

(21) Appl. No.: 19/212,428

(22) Filed: May 19, 2025

(51) Int. Cl. G06F 9/451

(52) U.S. Cl. CPC G06F 9/451

(57) ABSTRACT

A system identifies multiple data collection fields within an initial form. The system then generates a data collection interface with interface elements that accept user input for the identified collection fields. The system detects an updated version of the initial form. The system then updates the data collection interface by comparing collection fields between the updated form and the initial form. The system determines when the updated form includes additional collection fields absent from the initial form. The system modifies the data collection interface by adding new interface elements that accept user input for the additional collection fields. When the system determines that a form is of a new type, the system generates an new data collection interface for the form of the new type.

### TECHNICAL FIELD

The present disclosure relates generally to electronic forms processing and data collection interfaces, and more particularly, to systems and methods for managing the collection and processing of data related to forms.

### BACKGROUND

Organizations across various industries routinely manage numerous forms for regulatory compliance, business operations, and customer interactions. These forms include tax withholding documents, human resources paperwork, financial applications, and various government-mandated filings. A persistent challenge in this domain is the unpredictable and often unannounced manner in which these forms are updated by their publishing authorities.

Form publishers, including government agencies and regulatory bodies, regularly update their forms to reflect changes in policies, laws, or data collection requirements. These updates occur at irregular intervals, often without formal notification to the organizations that are required to implement them. Form changes range from minor modifications, such as version number updates or instruction clarifications, to significant structural changes, such as creating new data fields or eliminating existing ones.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a data collection interface update system in accordance with one or more embodiments;

FIGS. 2A and 2B illustrate an example set of operations for updating a data collection interface in accordance with one or more embodiments;

FIG. 2C illustrates an example set of operations for generating a new data collection interface for a new form in accordance with one or more embodiments;

FIG. 3 illustrates an exemplary update of a data collection interface in accordance with one or more embodiments; and

FIG. 4 shows a block diagram that illustrates a system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DATA COLLECTION INTERFACE UPDATE ARCHITECTURE
3. METHOD OF UPDATING DATA COLLECTION INTERFACE
4. METHOD OF GENERATING NEW DATA COLLECTION INTERFACE FOR NEW FORM
5. DATA COLLECTION INTERFACE UPDATE EXAMPLE
6. PRACTICAL APPLICATIONS, ADVANTAGES & IMPROVEMENTS
7. MISCELLANEOUS; EXTENSIONS
8. HARDWARE OVERVIEW

### 1. General Overview

Data collection interfaces are configured to present information associated with a form and collect data for completing the form. A form publisher often updates forms without notification. Some form updates are minor updates, such as a change in only a version number or change in instructions on how to complete a form. Other updates are more significant such as a change in the fields of the form.

One or more embodiments continuously, or periodically, update data collection interfaces in response to metadata-based detection of changes in underlying forms. The system generates and presents interfaces for collecting data corresponding to a set of forms. Furthermore, the system updates the data collection interfaces based on the latest version of a corresponding form. In an example, the system is configured to present information corresponding to a target form and obtain user input for completing the target form. The system periodically executes a trigger detection operation to detect triggers for updating the data collection interface. In one example, the system selects the frequency for executing the trigger detection operation based on a historical change frequency, historical change timing, priority score, or other attribute corresponding to the form. The trigger detection operation includes comparing the metadata associated with a target form with metadata associated with a candidate form from a form repository to evaluate one or more match criteria. In one example, the match criteria require that certain fields and/or information detected in the target form are present in the candidate form. In response to determining that the one or more match criteria are met, the system identifies the candidate form as an updated version of the target form. The system updates the data collection interface to present information and/or collect data based on the updated version of the target form.

One or more embodiments determine an update process for updating the data collection interface based on the characteristics of the changes to a target form. In an example, the system determines a change category based on the characteristics of the changes. In one example, based on the determined change category, the updates to the data collection interface are automatically completed and deployed without human intervention. Alternatively, based on the determined change category, the updates to the data collection interface are presented for approval prior to completion and/or prior to deployment.

One or more embodiments select a set of tests for testing the updated data collection interface based on the change category. Furthermore, the system applies a generative AI model to produce an explanation of the changes implemented in an updated version of the form. The system selects the set of tests based on the explanation produced by the generative AI model.

One or more embodiments described in this Specification and/or recited in the claims may not be included in this General Overview section.

### 2. Data Collection Interface Update Architecture

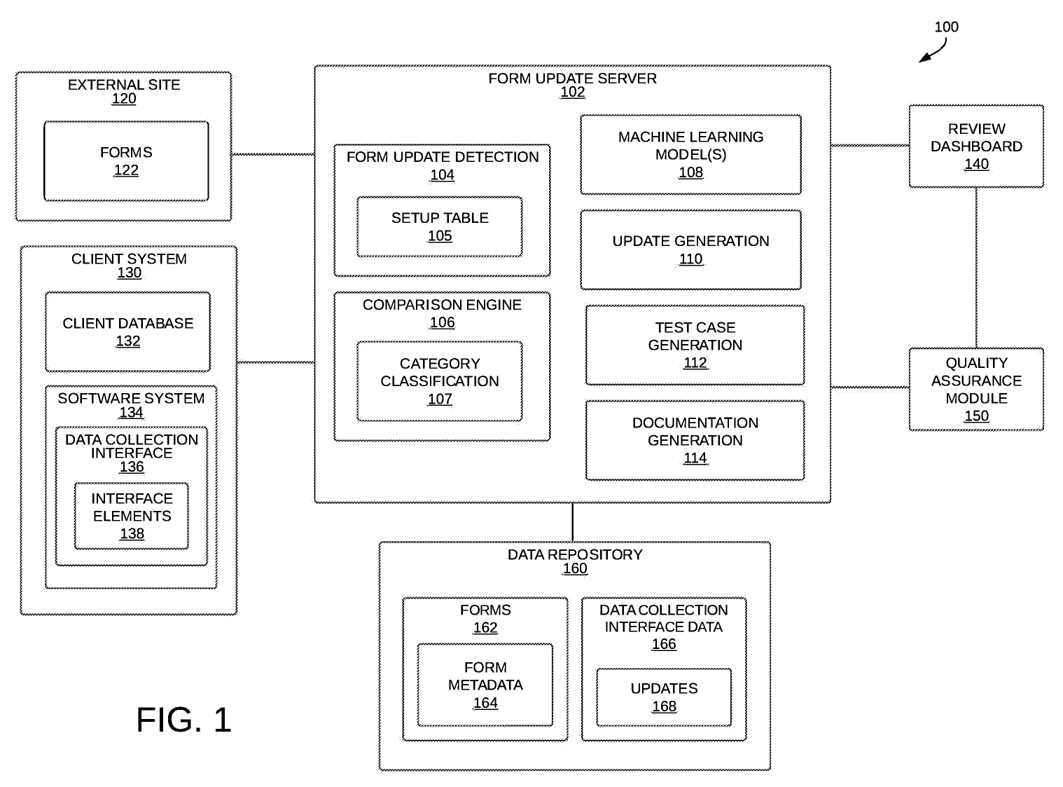

FIG. 1 illustrates a data collection interface update system 100 in accordance with one or more embodiments. As illustrated in FIG. 1, system 100 includes form update server 102, form update detection 104, setup table 105, comparison engine 106, category classification 107, machine learning model(s) 108, update generation 110, test case generation 112, documentation generation 114, external site 120, forms 122, client system 130, client database 132, software system 134, data collection interface 136, interface elements 138, review dashboard 140, quality assurance module 150, data repository 160, forms 162, form metadata 164, data collection interface data 166, and updates 168.

In an embodiment, form update server 102 retrieves forms from external sites 120, analyzes the forms, and updates data collection interfaces for client systems 130. Form update server 102 is deployed as a cloud-based service or as a dedicated server system. Form update server 102 automates the detection and classification of changes and connects to data repository 160 to store forms, metadata, and configurations. Form update server 102 executes scans based on historical patterns of when forms typically get updated.

In an embodiment, form update detection 104 executes periodic scanning operations to identify potential form updates from external repositories. Form update detection 104 accepts configuration parameters from setup table 105, defining search locations, identification keywords, and exclusion terms for specific form types. Form update detection 104 retrieves candidate forms from configured external sites and applies comparison techniques to identify potential updates to previously cataloged forms. Form update detection 104 implements scheduling algorithms that increase monitoring during historically active periods while reducing system resource utilization during typically inactive periods.

In an embodiment, setup table 105 stores configuration parameters for form monitoring operations, including uniform resource locator (URL) locations, search terms, and excluded terms. Setup table 105 includes multiple rows corresponding to different monitored forms, with rows specifying identification criteria. Setup table 105 enables differentiated monitoring strategies for various form types, including direct URL access for forms with stable locations versus keyword-based searching for forms published on directory pages. Setup table 105 supports configuration of exclusion terms to filter out irrelevant search results when scanning form repositories. In one embodiment, setup table 105 also includes form-specific actions that guide the update operation.

In an embodiment, comparison engine 106 analyzes candidate forms against baseline versions to identify substantive changes requiring implementation. Comparison engine 106 employs specialized algorithms for detecting field additions, removals, and modifications across multiple document formats, including portable document format (PDF), hypertext markup language (HTML), and image-based forms. Comparison engine 106 generates difference reports, highlighting detected changes with calculated confidence scores to guide subsequent processing decisions.

In an embodiment, category classification 107 evaluates detected form changes to identify distinct change types, including text-only modifications, field additions, field removals, and updates to selectable options within existing fields. In one example, the system applies different processing rules to text-only changes versus structural modifications affecting data collection capabilities. Category classification 107 flags text modifications for expedited processing when changes affect instructional content without altering data validation requirements. Category classification 107 routes field structure changes, including additions, removals, or option modifications through more rigorous verification pathways due to greater potential impact on client system operations.

In an embodiment, machine learning model(s) 108 apply artificial intelligence techniques to enhance multiple aspects of form update processing, including generation of implementation code. Machine learning model(s) 108 improve detection accuracy through pattern recognition trained on historical form update cycles across governmental and regulatory bodies. Machine learning model(s) 108 generate predicted change schedules based on historical publishing patterns, enabling proactive monitoring intensification during likely update periods. Machine learning model(s) 108 automatically produce implementation code for update generation 110 based on detected form changes, translating field additions, removals, and option modifications into executable interface updates. Machine learning model(s) 108 learn from previous successful implementations to continuously improve code generation quality and reduce manual intervention requirements for routine update scenarios.

In an embodiment, update generation 110 transforms detected form changes into implementation packages ready for deployment to client systems. Update generation 110 produces modified interface definitions, database schema adjustments, and business logic updates necessary for accommodating detected form changes. Update generation 110 preserves backward compatibility with existing data while implementing new requirements identified during form comparison. Update generation 110 incorporates validation rules, display constraints, and field relationships extracted from updated forms into implementation artifacts. Update generation 110 packages changes according to deployment methodologies appropriate for target client system architectures.

In an embodiment, test case generation 112 creates verification scenarios designed to validate proper implementation of form updates before deployment. Test case generation 112 develops input datasets targeting new fields, modified validation rules, and calculation dependencies introduced by form updates. Test case generation 112 produces boundary condition tests to verify proper handling of minimum and maximum values, special characters, and formatting requirements defined in updated forms.

In an embodiment, documentation generation 114 produces supporting documentation, such as explanatory materials describing form changes, implementation details, and deployment considerations. Documentation generation 114 creates administrator guides that explain configuration options available for newly implemented form elements. Documentation generation 114 develops end-user instructions that highlight changes users will encounter when completing updated forms through data collection interfaces. Documentation generation 114 maintains change history records that detail when updates occurred, what changed, and regulatory drivers behind modifications.

In an embodiment, external site 120 represents remote repositories where authoritative form versions are published by regulatory bodies or government agencies. External site 120 serves as primary data source for form update detection 104 when scanning for changed form versions. External site 120 publishes forms 122 through various distribution mechanisms, including direct downloads, searchable directories, or structured catalogs. External site 120 often updates published content without explicit notification to dependent systems, necessitating periodic scanning for detecting changes. External site 120 often maintains multiple form versions simultaneously during transition periods when regulatory changes occur or for archival purposes.

In an embodiment, forms 122 represent documents published by external authorities that define data collection requirements for regulatory, business, or governmental purposes. Forms 122 establish required fields, validation rules, calculation methods, and submission requirements for collecting structured information. Forms 122 undergo revision cycles whereby publishing authorities modify existing requirements, add new data collection fields, or remove or modify outdated information or instructions. Forms 122 exist in various formats, including interactive PDF documents, HTML web forms, or image-based documents that require extraction techniques to identify field structures. Forms 122 include both visible elements meant for human users and metadata attributes supporting automated processing.

In an embodiment, client system 130 hosts applications utilizing form-driven data collection processes that require synchronization with current authoritative versions. Client system 130 integrates with form update server 102 to receive interface modifications reflecting detected form changes. Client system 130 provides user-facing application environments where data collection interfaces 136 present current form requirements to end users. Client system 130 maintains client database 132 storing collected form data according to schemas aligned with current form requirements. Client system 130 implements business processes dependent on form-driven workflows, requiring timely updates when underlying forms change.

In an embodiment, client database 132 stores data collected through form interfaces along with supporting metadata about form versions and compliance status. Client database 132 maintains structured schemas corresponding to current form requirements while preserving historical data collected under previous form versions. Client database 132 implements validation constraints matching current form requirements for data integrity enforcement. Client database 132 supports reporting functions extracting collected data for submission to regulatory authorities according to mandated formats. Client database 132 maintains relationship structures between collected data elements, reflecting logical connections defined in source forms.

In an embodiment, software system 134 provides application logic that implement business processes built around form-based data collection. Software system 134 renders data collection interface 136 presenting form fields to users according to current form requirements. Software system 134 applies validation logic, conditional display rules, and calculation formulas that match specifications from authoritative form versions. Software system 134 processes user input against validation rules derived from form requirements before storage in client database 132. Software system 134 updates data collection interface 136 based on updates received from form update server 102 when underlying forms change.

In an embodiment, data collection interface 136 presents visual representations of form requirements through structured interactive elements for users inputting data. Data collection interface 136 arranges interface elements 138 according to logical groupings and dependencies defined in source forms. Data collection interface 136 applies visual styling appropriate for organizational branding while maintaining field relationships and instructions from original forms. Data collection interface 136 provides contextual help derived from instruction text extracted from source forms.

In an embodiment, interface elements 138 represent individual input components rendered within data collection interface 136 for capturing specific data points. Interface elements 138 include specialized input types matching form field requirements, such as text boxes, dropdown selections, checkboxes, or date pickers. Interface elements 138 incorporate validation rules that enforce data format, range limitations, or relationship constraints defined in source forms. Interface elements 138 display labels, instructions, and help text extracted from source forms to guide user input. Interface elements 138 receive dynamic updates when source forms change, adapting validation rules, display properties, or text accordingly.

In an embodiment, review dashboard 140 provides human oversight interfaces for monitoring and approving updates before deployment to production environments. Review dashboard 140 displays detected form changes highlighting additions, removals, and modifications identified by comparison engine 106. Review dashboard 140 presents implementation artifacts generated by update generation 110 for review by business analysts or compliance specialists. Review dashboard 140 facilitates approval workflows that collect necessary authorizations before changes deploy to client systems 130. Review dashboard 140 maintains approval history, documenting review decisions, approvers, and timestamps throughout change management processes.

In an embodiment, quality assurance module 150 executes testing procedures that verify correct implementation of form updates before production deployment. Quality assurance module 150 executes test scenarios developed by test case generation 112 against staging implementations of updated forms. Quality assurance module 150 validates that field additions, removals, and modifications function correctly within integrated environments. Quality assurance module 150 verifies calculation accuracy, conditional logic operation, and validation rule enforcement matching specifications from updated forms.

In one or more embodiments, data repository 160 is any type of storage unit and/or device (e.g., a file system, database, collection of tables, or any other storage mechanism) for storing data. Furthermore, data repository 160 may include multiple different storage units and/or devices. The multiple different storage units and/or devices may or may not be of the same type or located at the same physical site. Furthermore, data repository 160 may be implemented or executed on the same computing system as form update server 102. Additionally, or alternatively, data repository 160 may be implemented or executed on a computing system separate from form update server 102. Data repository 160 may be communicatively coupled to form update server 102 via a direct connection or via a network.

In an embodiment, forms 162 within data repository 160 represent captured instances of authoritative forms from external sites, stored for processing and historical reference. Forms 162 include current production versions against which candidate forms compare during update detection processes. Forms 162 maintain historical version sequences that document evolution of form requirements over time. Forms 162 support extraction of field definitions, validation rules, and calculation formulas during interface generation processes. Forms 162 serve as reference points for verifying correct implementation during quality assurance procedures.

In an embodiment, form metadata 164 stores structured information about form characteristics, supporting identification and comparison operations. Form metadata 164 includes extracted attributes, such as version numbers, effective dates, revision codes, and authoritative source identifiers. Form metadata 164 catalogs field inventories that document input elements, validation rules, and conditional logic of the forms. Form metadata 164 supports rapid comparison operations without requiring complete document analysis during initial matching phases.

In an embodiment, data collection interface data 166 defines implementation specifications, translating form requirements into interactive user interfaces. Data collection interface data 166 maps form fields to appropriate interface element types based on input requirements and validation constraints. Data collection interface data 166 preserves logical groupings, section organization, and conditional relationships defined in source forms. Data collection interface data 166 includes presentation attributes that determine how interface elements render within client applications. Data collection interface data 166 supports version tracking, ensuring interfaces align with current authoritative form requirements.

In an embodiment, updates 168 document changes implemented in response to form modifications detected by system 100. Updates 168 record various detailed change specifications, including field additions, removals, validation adjustments, and instruction modifications. Updates 168 preserve approval records, linking changes to authorization events recorded through review dashboard 140. Updates 168 support audit processes, demonstrating timely implementation of regulatory form changes when required for compliance purposes.

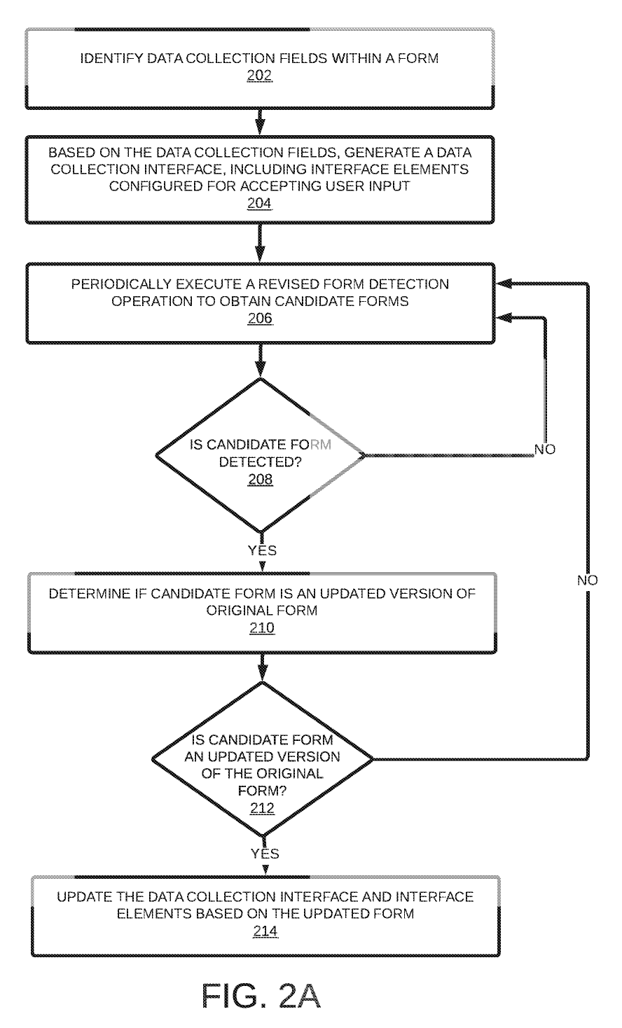

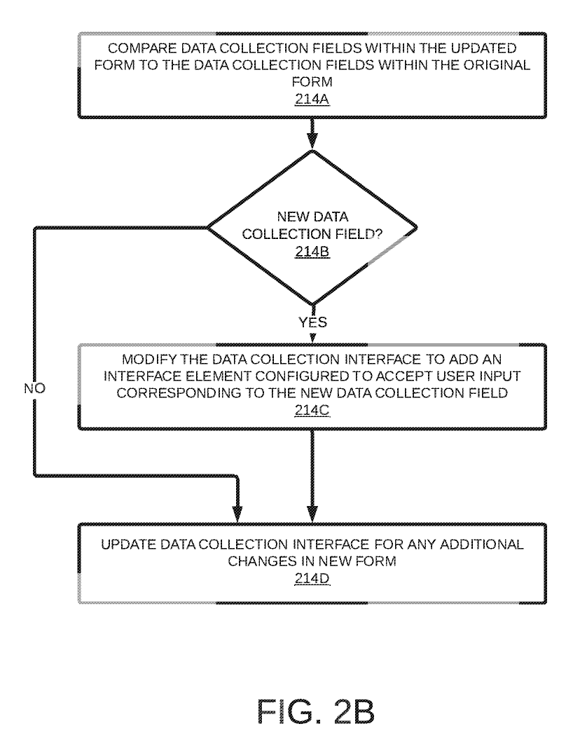

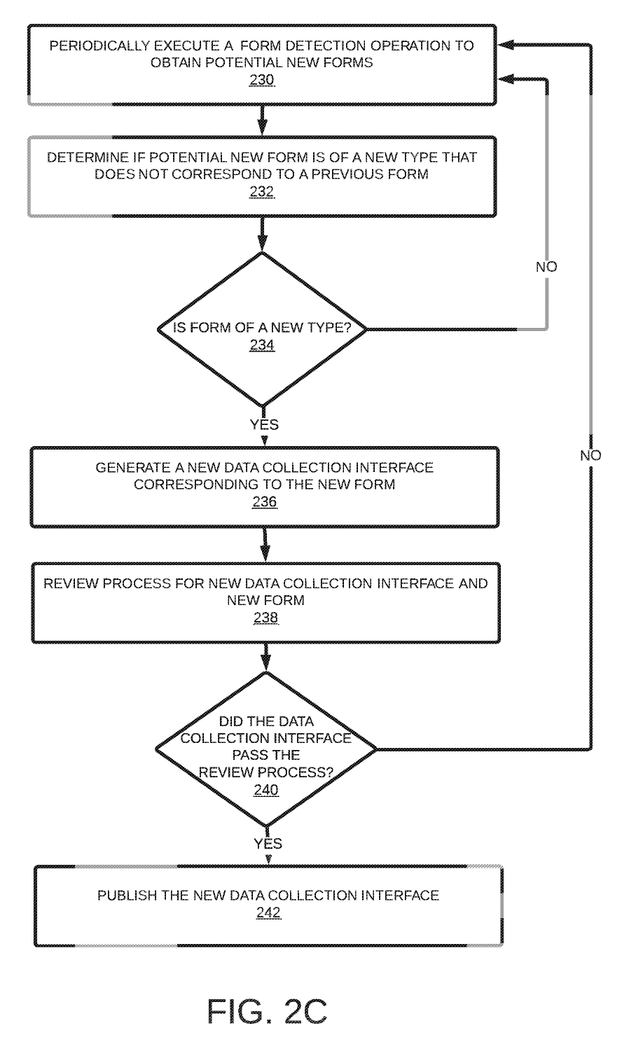

In an embodiment, as discussed in more detail with respect to FIG. 2C below, form update server 102 retrieves forms from external sites 120, analyzes the forms, and updates data collection interfaces for client systems 130 while also detecting and processing entirely new form types. Form update detection 104 executes periodic scanning operations to identify both potential form updates and completely new forms never previously encountered, applying comparison techniques to calculate similarity scores that distinguish updates from new form types. Category classification 107 evaluates detected forms to determine whether they represent modifications to existing forms or entirely new form types requiring generation of completely new interfaces rather than updates to existing ones, routing new form types through specialized workflows for interface creation. Review dashboard 140 provides oversight capabilities for both form updates and newly created interfaces, displaying interface specifications for new form types alongside implementation artifacts, and facilitating review paths for newly created interfaces requiring more comprehensive validation before deployment to client systems.

In one or more embodiments, form update server 102, form update detection 104, setup table 105, comparison engine 106, category classification 107, machine learning model(s) 108, update generation 110, test case generation 112, documentation generation 114, client database 132, software system 134, data collection interface 136, interface elements 138, review dashboard 140, and quality assurance module 150 refer to hardware and/or software configured to perform operations described herein for form updates.

In an embodiment, form update server 102, form update detection 104, setup table 105, comparison engine 106, category classification 107, machine learning model(s) 108, update generation 110, test case generation 112, documentation generation 114, client database 132, software system 134, data collection interface 136, interface elements 138, review dashboard 140, and quality assurance module 150 are implemented and/or stored on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, , a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Method of Updating Data Collection Interface

FIGS. 2A and 2B illustrate an example set of operations for updating a data collection interface in accordance with one or more embodiments. One or more operations illustrated in FIGS. 2A and 2B may be modified, rearranged, or omitted. Accordingly, the particular sequence of operations illustrated in FIG. 2A and 2B should not be construed as limiting the scope of one or more embodiments.

Looking at FIG. 2A, in an embodiment, the system identifies data collection fields within a form (Operation 202). The system finds areas where users enter information on the form and recognizes them as input fields by scanning the document with optical character recognition, analyzing spatial relationships between text elements, or identifying form structures through pattern recognition. The system extracts structured information from the form, including input fields, instruction text, and calculation requirements. The system recognizes different field types, including text entry fields, selection options, checkbox elements, and numeric input areas. The system extracts and associates instruction text with corresponding input fields. The system catalogues these data collection fields along with their attributes for subsequent interface generation.

In an embodiment, the system generates a data collection interface, including interface elements configured for accepting user input based on the identified data collection fields (Operation 204). The system builds a digital form with appropriate input controls that correspond to fields found in the original document by analyzing field characteristics, applying interface design patterns, and programmatically generating components that render as interactive form elements in a web browser or other interface display. The system translates identified data collection fields from the form into appropriate interface element types, such as text boxes, dropdown menus, radio buttons, or checkboxes. The system examines the fields to determine their purpose and expected input type. For example, fields requiring short text entries become simple text boxes, while fields with limited option choices transform into dropdown menus or radio buttons, depending on the number of choices and selection requirements.

In an embodiment, the system determines appropriate validation rules based on field context and labeled expectations. Social Security Number fields receive nine-digit formatting masks with automatic hyphen insertion, while date fields transform into specialized date pickers with appropriate range limitations. Address fields get broken into component parts with appropriate validation for postal codes, states, and street numbers. The system recognizes common patterns across form types, applying standardized transformations while preserving the specific requirements unique to the forms.

In an embodiment, the system arranges interface elements to match the logical flow of the original form while improving usability. Related fields group together visually, section headers maintain hierarchical organization, and conditional logic hides irrelevant sections based on previous selections. Help text and instructions position strategically near relevant fields, appearing when users interact with those sections. The resulting interface balances regulatory compliance with improved user experience, maintaining the integrity of the original form requirements while making completion easier and more accurate for end users.

In an embodiment, the system employs specialized extraction techniques to interpret both visible and hidden form structures when processing PDF forms. The system scans PDF documents using optical character recognition for non-interactive PDFs, identifying field boundaries and labels through spatial analysis. For interactive PDFs with embedded form fields, the system directly accesses the underlying form definition, extracting field properties, validation rules, and relationships without requiring visual interpretation. PDF metadata provides additional context about form version, origin, and official status. The system preserves PDF-specific features, such as calculated fields and cross-references between sections.

In an embodiment, the system periodically executes a revised form detection operation to obtain candidate forms (Operation 206). The system executes scheduled searches at defined intervals to locate potentially updated versions of monitored forms by executing automated web crawlers that target government and regulatory websites, performing requests to known form repositories, and applying document filtering algorithms to identify potential form updates from search results. The system accesses external repositories according to schedules determined by historical update patterns for specific form types. Scanning routines adapt over time, learning from previous update cycles to focus resources where changes appear most likely. Candidate forms undergo metadata extraction, preparing for detailed comparison phases following initial detection.

In an embodiment, the system monitors federal and state tax withholding forms along with human resources forms, such as veteran self-identification and disability self-identification documents. The system applies specialized detection algorithms calibrated for form types, enabling comprehensive coverage across diverse regulatory requirements. Form monitoring includes continuous evaluation of repository sources where publishing authorities post updated versions, with detection sensitivity adjusted according to historical update patterns specific to form categories.

In an embodiment, the system processes multiple form types, including payroll forms, human resources forms, benefits forms, and financial forms, through configurable processing pipelines tailored to the category’s unique characteristics. Payroll forms receive specialized handling for tax calculation dependencies. Benefits forms incorporate validation rules that preserve enrollment eligibility criteria, while financial forms maintain audit trail documentation that satisfy regulatory compliance standards. The system applies appropriate processing rules to the form types based on classification parameters defined in the setup configuration.

In an embodiment, the system selects a frequency for periodically executing the revised form detection operation based on historical form change frequency, historical form change timing, or a priority score corresponding to the form. The system maintains records of past form updates, including frequency, timing patterns, and update significance, for monitored forms. Frequency selection creates dynamic scanning schedules that intensify during high-activity periods, like tax season, for financial forms.

In an embodiment, the system implements daily scanning operations that monitor external repositories where form authorities publish updates. Daily execution increases detection timing without overwhelming system resources. The system distributes scanning operations across time periods, minimizing impact on overall system performance while maximizing detection sensitivity. Daily operations exceed typical human monitoring operations (that typically follow weekly or monthly cycles due to resource constraints), thereby improving update response times across monitored form types.

In an embodiment, the system detects candidate forms using a setup table indicating a URL location, a search term and an excluded term. The system obtains the candidate form from the specified URL location when a title or metadata of the candidate form matches the search term but excludes the excluded term. Flexible configuration approaches allow targeting of form sources across various government and regulatory websites.

In an embodiment, the system determines if a candidate form detection occurred (Operation 208). If the system determines that a candidate form detection occurred in operation 208, then the system proceeds to operation 210. Else, the system returns to operation 206.

In an embodiment, the system determines if the candidate form represents an updated version of the original form (Operation 210). The system analyzes and compares the candidate form with previously known versions to verify it is indeed a newer revision of the same form by extracting metadata, such as version numbers and dates, calculating similarity scores based on structural elements and content, and applying machine learning algorithms trained to recognize document relationships despite formatting changes. The system compares metadata extracted from the candidate form against stored information about previously identified forms to evaluate version relationships. Additionally, or alternatively, the system uses displayed data in the form, such as titles and dates. For example, a new W-2 form for the tax year 2025 will include the text “W-2” and “2025”. Similarity scoring algorithms weigh various structural and content elements to understand document relationships. The system employs a confidence measurement mechanism for form identification and matching. The system calculates proximity scores or matching percentages when comparing candidate forms against previous form versions. In one example, the system processes forms with exceptionally high scores with minimal human intervention, while borderline matches trigger additional verification steps.

In an embodiment, the system implements PDF metadata extraction and analysis capabilities. The system detects the updated form by identifying candidate forms, possibly including the updated version of the original form, and comparing metadata associated with candidate forms to metadata associated with the original form to determine form match criteria satisfaction.

In an embodiment, based on operation 210, the system determines if the candidate form represents an updated version of the original form (Operation 212). If the candidate form represents an updated version of the original form, then the system proceeds to operation 214. Else, the system returns to operation 206.

In an embodiment, the system updates the data collection interface and interface elements based on the updated form (Operation 214). The system applies detected changes from the new form version to the data collection interface, so the data collection interface accurately reflects the current requirements by generating code changes to user interface components, updating database schemas to accommodate new data structures, and/or modifying validation rules to enforce revised field requirements. The system analyzes differences between the original form and updated version to identify specific modifications requiring implementation. After implementation, packaged deployment updates, or artifacts, undergo testing before reaching client systems, minimizing disruption while maximizing accuracy.

In an embodiment, the system features autonomous code generation capability for implementing form updates. The system translates detected form changes into corresponding implementation code artifacts through a machine learning model trained on historical modification patterns. AI-driven approaches accelerate implementation while maintaining consistency across updates. Implementation packages address affected system layers, such as database schemas and user interfaces. By generating standardized code following established patterns, implementation time decreases alongside future maintenance work.

In an embodiment, the system provides a workflow for managing form updates through a dashboard. When the system determines data collection fields in the proposed update form include differences relating to data collection fields in the original form, the system determines change categories associated with differences. The change categories trigger either (a) an automated process for updating the data collection interface without human intervention or (b) a semi-automated process that presents updates to the data collection interface for human approval prior to implementation.

In an embodiment, the system supports user review options through the dashboard for responding to detected form changes. Users may accept changes for immediate implementation when modifications align with current business requirements. Alternatively, users may decline changes permanently when proposed updates are irrelevant or unnecessary. Users may mark changes for re-evaluation if additional information or stakeholder input becomes necessary before implementation decisions. Furthermore, users may override recommendations with alternate solutions to create a modified or customized update that differs from the system-generated suggestions. The system records decisions with appropriate audit documentation, supporting compliance verification requirements.

In an embodiment, the system employs intelligent categorization to route different change types through appropriate validation channels based on potential impact. Field additions, field removals, and selection value modifications undergo mandatory routing to the quality assurance (QA) module for comprehensive testing before implementation. The QA module executes predefined test scenarios against modified fields, verifying proper data capture, validation behavior, and system integration. Test scenarios simulate various user inputs, including boundary conditions, invalid data attempts, and expected use cases. Field changes that trigger calculation dependencies receive additional testing across multiple permutations of possible inputs, ensuring mathematical accuracy throughout connected form components.

In an embodiment, text-only modifications without structural or validation implications bypass the intensive QA process, proceeding directly to implementation after dashboard acceptance. Such changes include label text revisions, instruction clarifications, and help text updates, where underlying form functionality remains unchanged.

In an embodiment, a machine learning model generates test cases tailored to specific form field changes detected during update processing. Machine learning models analyze historical form usage patterns, previous error conditions, and common user input scenarios to develop test cases targeting potential weak points in modified fields. For numeric fields, test generators automatically identify boundary values, threshold conditions, and calculation edge cases requiring validation. Selection field test cases explore combinations of options affecting downstream conditional fields or calculations.

In an embodiment, the system automatically generates detailed update summaries for updates. The update summaries document form changes, testing processes, and implementation requirements for review. The system generates automatically upon change detection but remains dynamically updated throughout testing and implementation phases, providing real-time progress tracking.

In an embodiment, the system implements customer-specific notification and deployment mechanisms for the data collection interface. The system maintains customer profiles, including geographical distribution of employees, historical form utilization patterns, and business-critical processes dependent on specific form types. By analyzing workforce distribution data, the system prioritizes updates affecting the largest segments of customer employee bases. For example, depending on a client company’s workforce, the system prioritizes and rushes a change to a California withholding form for the client company while saving a change to an Arizona withholding form until a larger update patch.

Looking at FIG. 2B, details regarding an example of updating the data collection interface and interface elements based on the updated form for operation 214 are described. This example is merely illustrative, and other ways of implementing operation 214 may be done.

In an embodiment, the system compares data collection fields within the updated form to data collection fields within the original form (Operation 214A). The system performs a direct comparison between old and new versions of the form to identify fields that has changed by parsing both documents into structured data representations, using field identifiers and positional analysis to match corresponding elements, and applying difference detection algorithms that highlight additions, removals, and modifications. The system executes field-by-field comparison to identify additions, removals, and modifications between form versions.

In an embodiment, the system determines if new data collection fields exist in the updated form (Operation 214B). The system identifies any fields that appear in the updated form but were not present in the original version by creating field inventories for both documents, performing set difference operations to isolate unique elements, and filtering results through validation checks that confirm detected fields are genuinely new rather than modified existing fields. If the system determines that new data collection fields exist in the updated form, then the system proceeds to operation 214C. Else, the system skips to operation 214D. The system evaluates comparison results to identify data collection fields present in the updated form but absent from the original version.

In an embodiment, the system modifies the data collection interface to add interface elements configured to accept user input corresponding to new data collection fields (Operation 214C). The system creates new input controls for newly detected fields and integrates them into the existing digital form by generating appropriate user interface (UI) components based on field type analysis, extending database schemas with new columns or tables, and updating form processing code to handle the additional data collection points. The system creates appropriate interface components based on types and attributes of newly identified fields. Component creation applies consistent design patterns across interfaces, maintaining visual and functional coherence despite additions. Implementations address application layers, such as database schema and business logic, ensuring new fields function correctly throughout entire systems. User guidance derived from extracted form instructions helps users understand purposes and requirements of new fields upon deployment.

In an embodiment, the system updates the data collection interface for additional changes in new form (Operation 214D). The system processes remaining modifications, including removed fields, altered selections, and text changes, to synchronize the interface by removing obsolete UI components, updating dropdown options and checkbox labels to reflect new selections, modifying text content in instruction sections, and ensuring validation rules align with revised requirements. The additional changes include any field removals, answer options, and text changes.

In an embodiment, the system determines data collection fields in updated forms exclude data collection fields included in original forms. The system modifies the data collection interface to remove interface elements configured to accept user input corresponding to removed data collection fields. Removal processes consider dependencies throughout systems, preventing unexpected errors or cascading failures. Historical data remains preserved and accessible for reporting and compliance purposes, while interfaces prevent new data entry. Database and business logic updates maintain system integrity despite removed fields, ensuring smooth operation without disruption to users.

In an embodiment, the system determines input options for data collection fields in updated forms differ from input options for corresponding data collection fields in original forms. The system identifies interface elements configured to accept input from original option sets and reconfigures elements to accept input from the new option sets. Reconfigurations maintain backward compatibility with previously stored data while seamlessly adding support for new options. Validation rule updates ensure users select valid options from modified sets. Calculations or conditional logic dependent on field values automatically update to accommodate new option possibilities.

In an embodiment, the system determines text associated with data collection fields in updated forms that differs from text for corresponding data collection fields in original forms. The system identifies interface elements comprising instructions based on original text and modifies elements to include instructions based on new text. Text processing handles various special cases, such as accented characters and length constraints. In an example, the system detects that the text in the updated form would exceed a character limit for the data collection field of the data collection interface and generates an abbreviated version of the text that complies with the character limit. The system handles multilingual content such as by removing potentially problematic accents without losing meaning. When facing lengthy instructions exceeding system limits, the system condenses text while preserving essential information and regulatory compliance. Additionally, the system implements progressive disclosure techniques to manage infrequently relevant text by initially displaying essential instructions while providing expandable sections or help functionality for detailed guidance, regulatory citations, and edge-case scenarios that most users rarely need. Alternately, the system completely removes such infrequently relevant text. The system also processes form content during updates to ensure compatibility with system constraints.

### 4. Method of Generating New Data Collection Interface for New Form

FIG. 2C illustrates an example set of operations for generating a new data collection interface for a new form in accordance with one or more embodiments. One or more operations illustrated in FIG. 2C may be modified, rearranged, or omitted. Accordingly, the particular sequence of operations illustrated in FIG. 2C should not be construed as limiting the scope of one or more embodiments. The operations of FIG. 2C may be done in parallel with the operations of FIGS. 2A and 2B discussed above.

In an embodiment, the system periodically executes a form detection operation to obtain potential new forms (Operation 230). The system schedules and performs automated scanning operations at predefined intervals to discover forms published by external authorities such as government agencies or regulatory bodies. During these scheduled scans, the system accesses configured external sites, applies filtering criteria based on setup configuration parameters, and collects any forms matching the designated search parameters.

In an embodiment, the system determines if potential new form is of a new type that does not correspond to a previous form (Operation 232). The system analyzes detected forms against a database of known form types to establish whether the discovered form represents an entirely new category rather than merely an updated version of an existing form. The system applies pattern recognition techniques to extract key identifiers from the form content, structure, and metadata to establish form identity. The system calculates similarity scores by comparing the detected form against records of previously supported forms stored in the data repository. The system flags forms with low similarity scores across all existing form categories as potentially representing new form types requiring creation of entirely new data collection interfaces rather than updates to existing interfaces.

In an embodiment, the system evaluates whether the discovered form constitutes a new form type (Operation 234). If the analysis in Operation 232 results in similarity scores below established thresholds across all existing form categories, the system designates the form as a new type. When the decision in operation 234 indicates the form lacks correspondence to an existing type, the system returns to operation 230 to continue monitoring for additional form changes. When the decision in operation 234 indicates the form represents a genuinely new type, the system proceeds to operation 236 to create a completely new data collection interface.

In an embodiment, the system generates a new data collection interface corresponding to the new form (Operation 236). The system creates an entirely new set of interface specifications tailored specifically to the requirements of the newly discovered form type rather than modifying an existing interface. The system analyzes the structure of the new form to identify data collection fields, required input formats, validation rules, and logical relationships between form sections. The system generates appropriate interface elements for each identified data collection point, mapping form requirements to suitable input controls such as text fields, dropdown selections, radio buttons, or specialized input components. The system applies design patterns consistent with existing interfaces while accommodating the unique characteristics of the new form type.

In an embodiment, the system extracts field specifications from the new form to determine appropriate input controls for the data collection interface. For text entry fields, the system analyzes surrounding context to determine expected data format, minimum and maximum length requirements, and any special formatting expectations such as specific patterns for identification numbers or code values. For selection fields, the system identifies available options, determines whether single or multiple selections are permitted, and extracts any conditional logic governing when specific options become available based on previous selections. For numeric fields, the system determines acceptable ranges, decimal precision requirements, and any calculation dependencies with other form fields.

In an embodiment, the system reviews the organization of the new form to establish appropriate grouping and sequencing of interface elements. The system identifies section headers, field groupings, and hierarchical relationships within the form to create a logical interface structure matching the organization of the original form. The system preserves conditional relationships where certain fields or sections become relevant based on responses to previous questions. The system extracts instructional text associated with form sections and individual fields to incorporate appropriate guidance within the data collection interface. The system determines whether progressive disclosure techniques should implement to manage complex conditional sections of the form.

In an embodiment, the system initiates a review process for new data collection interface and new form (Operation 238). The system routes the newly generated data collection interface through a structured approval workflow designed to validate accuracy, completeness, and usability before deployment to production environments. The system presents the generated interface alongside source form documentation through the review dashboard to appropriate reviewers based on form type, typically including business analysts, compliance specialists, and user experience designers. The system captures feedback from reviewers regarding the interface implementation, including suggestions for modifications to improve usability while maintaining compliance with form requirements. The system tracks review status through defined workflow stages until receiving final determination regarding approval or rejection. In an embodiment, the system uses a review dashboard with capabilities for evaluating newly generated interfaces during Operation 238.

In an embodiment, the system determines if the data collection interface passes the review process (Operation 240). The system evaluates whether all required approvals have been received and any mandatory modifications have been completed satisfactorily. When the decision in operation 240 indicates review rejection or required modifications, the system returns to incorporate feedback and generate revised implementation. When the decision in operation 240 indicates successful approval, the system proceeds to operation 242 to finalize deployment. The system maintains audit records documenting the review process, including reviewer identities, approval timestamps, and any exceptions or special considerations noted during review.

In an embodiment, the system publishes the new data collection interface (Operation 242). The system finalizes approved interface specifications and deployment packages, making the new form interface available for production use across client systems. The system generates deployment artifacts including interface definition files, database schema modifications, validation rules, and supporting documentation describing the new form implementation. The system updates metadata records in the data repository to register the new form type, establishing baseline versions for future comparison when monitoring for subsequent form updates. The system notifies appropriate stakeholders about the availability of the new form interface, including customer administrators responsible for enabling access to the new functionality within their organizations.

### 5. Data Collection Interface Update Example

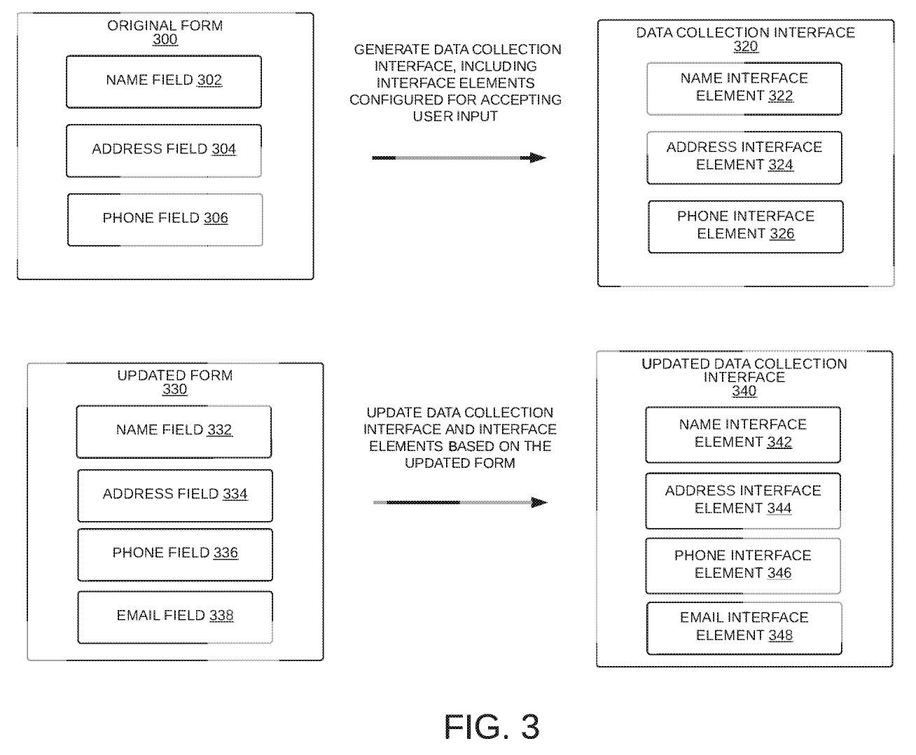

FIG. 3 illustrates an exemplary update of a data collection interface in accordance with one or more embodiments. FIG. 3 shows adding a new field to an existing form.

In an embodiment, the original form 300 on the left side of the diagram includes three fields that collect contact information: name field 302, address field 304, and phone field 306. When original form 300 undergoes initial processing by the system, the system generates a corresponding data collection interface 320 that includes interface elements matching fields from the form: name interface element 322, address interface element 324, and phone interface element 326. These interface elements appear in the user interface and allow users to enter contact information in a digital format. The interface elements collect the appropriate type of data and include validation rules to ensure entered data meet requirements specified in original form 300.

In an embodiment, form publishers update forms to collect additional information over time. In the example shown in FIG. 3, updated form 330 includes name field 332, address field 334, phone field 336, and newly added email field 338. The addition of email field 338, absent from original form 300, represents a common scenario where organizations need to collect additional contact methods from users.

In an embodiment, the system detects updated form 330 through monitoring processes (detailed in FIG. 2A) and performs a comparison between original form 300 and updated form 330. During comparison, the system identifies email field 338 as new without a corresponding field in original form 300. Following the process flow shown in FIG. 2B (operations 214A through 214C), the system determines a new data collection field exists and modifies the data collection interface accordingly.

In an embodiment, the result becomes updated data collection interface 340, now including name interface element 342, address interface element 344, phone interface element 346, and newly added email interface element 348. Email interface element 348 represents the tangible outcome of the system’s form update detection and processing capabilities. The new email interface element 348 enables users to enter email addresses, applying appropriate validation rules to ensure data meets format requirements, such as including the @ symbol and proper domain structure.

In an embodiment, FIG. 3 demonstrates automatically detecting and implementing changes to forms without requiring manual intervention. The detection of email field 338 and subsequent addition of corresponding interface element 348 occurs through processes described in FIGS. 2A and 2B. Forms undergo various types of updates, including adding fields, removing fields, modifying field options, or changing instruction text. The email field addition shown in FIG. 3 provides visualization of how the system handles common update scenarios.

In an embodiment, organizations using this system benefit from reduced implementation time and consistent handling of form updates. Rather than manually identifying new email field requirements and coding corresponding interface elements, the system automatically detects changes and generates necessary interface updates, ensuring digital data collection processes remain aligned with latest form requirements.

### 6. Practical Application, Advantages, & Improvements

The system provides technical improvements to computer networks through automated form interface generation. By dynamically creating standardized interfaces for various form types, the system eliminates the need for redundant interface development across distributed computing environments. This standardization allows for more efficient resource utilization within network infrastructures and reduces development overhead. The system eliminates manual reconfiguration needs when forms undergo modifications across network environments. Through metadata-driven configuration adjustments, the system automatically propagates necessary changes to affected system components without always requiring manual intervention. In an embodiment, the system reduces form update implementation time from weeks to days through automated processing workflows that eliminate manual intervention requirements for routine modifications.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

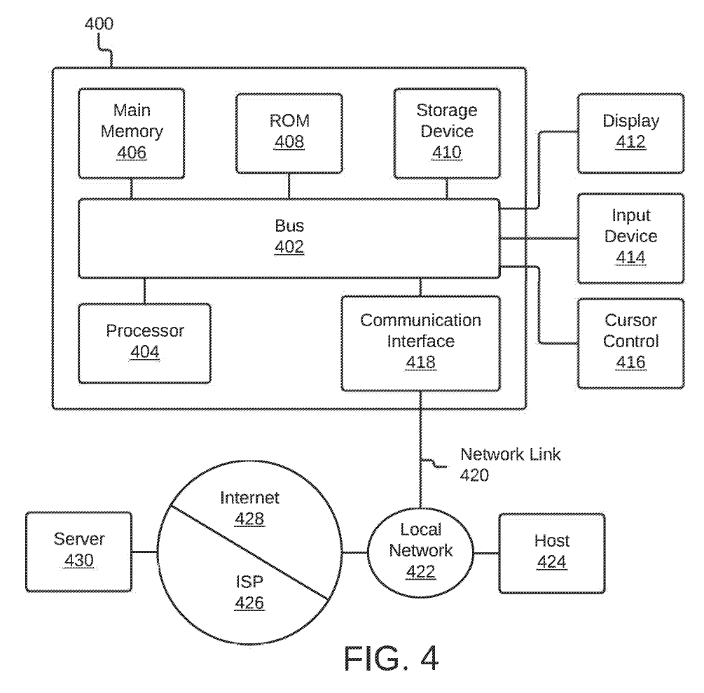

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware, and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

What is claimed is:

1. A method comprising:
identifying a first plurality of data collection fields within a first form;
based on the first plurality of data collection fields, generating a data collection interface comprising a plurality of interface elements configured for accepting user input corresponding to the first plurality of data collection fields;
detecting a second form that is an updated version of the first form;
updating the data collection interface based on the second form at least by:
comparing a second plurality of data collection fields within the second form to the first plurality of data collection fields within the first form;
determining that the second plurality of data collection fields includes a first data collection field that is not included in the first plurality of data collection fields; and
modifying the data collection interface to add a first interface element that is configured to accept first user input corresponding to the first data collection field,
wherein the method is performed by at least one device including a hardware processor.

2. The method of claim 1, wherein detecting the second form that is the updated version of the first form comprises:
identifying a plurality of candidate forms that may include the updated version of the first form, the plurality of candidate forms comprising the second form; and
comparing first metadata associated with each of the candidate forms to second metadata associated with the first form to determine that the second form meets one or more form match criteria in relation to the first form.

3. The method of claim 1, wherein the data collection interface is updated based on the second form further by:
determining that the second plurality of data collection fields does not include a second data collection field that was included in the first plurality of data collection fields;
modifying the data collection interface to remove a second interface element, from the plurality of interface elements, that was configured to accept second user input corresponding to the second data collection field.

4. The method of claim 1, wherein the data collection interface is updated based on the second form further by:
determining that a first set of input options, for a second data collection field of the second plurality of data collection fields, is different from a second set of input options, for a third data collection field of the first plurality of data collection fields, wherein the second data collection field of the second plurality of data collection fields corresponds to the third data collection field of the first plurality of data collection fields;
identifying a third interface element, from the plurality of interface elements, that was configured to accept one of the second set of input fields for the third data collection field; and
reconfiguring the third interface element to accept one of the first set of input fields for the second data collection field.

5. The method of claim 1, further comprising:
determining that a first text associated with a second data collection field of the second plurality of data collection fields, is different from a second text for a third data collection field of the first plurality of data collection fields, wherein the second data collection field of the second plurality of data collection fields corresponds to the third data collection field of the first plurality of data collection fields;
identifying a fourth interface element, from the plurality of interface elements, comprising a first instruction that is based on the first text associated with the second data collection field; and
modifying the fourth interface element to include a second instruction that is based on the second text for the third data collection field.

6. The method of claim 5, wherein modifying the fourth interface element to include a second instruction that is based on the second text for the third data collection field further comprising:
detecting that the second text in the second form exceeds a character limit; and
generating an abbreviated version of the second text that complies with the character limit as the second instruction.

7. The method of claim 1, further comprising:
determining that the second plurality of data collection fields includes a difference in relation to the first plurality of data collection fields;
determining a change category associated with the difference; and
selecting one of (a) an automated process for updating the data collection interface that does not involve human intervention or (b) a semi-automated process for updating the data collection interface that presents updates to the data collection interface for human approval prior to implementation of the updates.

8. The method of claim 1, wherein the second form is detected via a revised form detection operation, and wherein the operations further comprise selecting a frequency for periodically executing the revised form detection operation based on at least one of: a historical form change frequency, a historical form change timing, or a priority score corresponding to the first form.

9. The method of claim 1, wherein the second form is detected via a revised form detection operation, and the revised form detection operation uses a setup table that indicates a URL location, a search term and an excluded term, and wherein the second form is obtained from the URL location when a title or metadata of the second form matches the search term but does not match the excluded term.

10. The method of claim 1, further comprising:
before modifying the data collection interface to add the first interface element, sending a proposed update to a dashboard for acceptance,
accepting the proposed update at the dashboard;
generating, by a machine learning model, a test case for review; and
sending the proposed update to a quality assurance (QA) process for review along with the test case generated by the machine learning model.

11. The method of claim 10, further comprising:
generating supporting documentation for the proposed update based on the determined difference between the first plurality of data collection fields and the second plurality of data collection fields; and
integrating the supporting documentation with the proposed update sent to the quality assurance process.

12. The method of claim 1, further comprising:
detecting a third form that is not that is an updated version of previously detected forms;
generating a second data collection interface based on the third form at least by:
determining that the third form is of a new type that does not correspond to the previously detected forms;
identifying a third plurality of data collection fields within the third form;
creating a second plurality of interface elements configured for accepting user input corresponding to the third plurality of data collection fields; and
producing the second data collection interface using the second plurality of interface elements.

13. The method of claim 12, further comprising:
initiating a review process for the second data collection interface; and
publishing the second data collection interface upon approval in the review process.

14. The method of claim 12, wherein determining that the third form is of the new type comprises:
calculating similarity scores by comparing the third form against records of the previously detected forms; and
flagging the third form as a new form type when similarity scores fall below an established threshold.

15. One or more non-transitory computer readable media comprising instructions which, when executed by one or more hardware processors, cause performance of operations comprising:
identifying a first plurality of data collection fields within a first form;
based on the first plurality of data collection fields, generating a data collection interface comprising a plurality of interface elements configured for accepting user input corresponding to the first plurality of data collection fields;
detecting a second form that is an updated version of the first form;
updating the data collection interface based on the second form at least by:
comparing a second plurality of data collection fields within the second form to the first plurality of data collection fields within the first form;
determining that the second plurality of data collection fields includes a first data collection field that is not included in the first plurality of data collection fields; and
modifying the data collection interface to add a first interface element that is configured to accept first user input corresponding to the first data collection field.

16. The non-transitory media of claim 15, further comprising:
detecting a third form that is not that is an updated version of previously detected forms;
generating a second data collection interface based on the third form at least by:
determining that the third form is of a new type that does not correspond to the previously detected forms;
identifying a third plurality of data collection fields within the third form;
creating a second plurality of interface elements configured for accepting user input corresponding to the third plurality of data collection fields; and
producing the second data collection interface using the second plurality of interface elements.

17. The non-transitory media of claim 15, wherein detecting the second form that is the updated version of the first form comprises:
identifying a plurality of candidate forms that may include the updated version of the first form, the plurality of candidate forms comprising the second form; and
comparing first metadata associated with each of the candidate forms to second metadata associated with the first form to determine that the second form meets one or more form match criteria in relation to the first form.

18. A system comprising:
at least one device including a hardware processor;
the system being configured to perform operations comprising:
identifying a first plurality of data collection fields within a first form;
based on the first plurality of data collection fields, generating a data collection interface comprising a plurality of interface elements configured for accepting user input corresponding to the first plurality of data collection fields;
detecting a second form that is an updated version of the first form;
updating the data collection interface based on the second form at least by:
comparing a second plurality of data collection fields within the second form to the first plurality of data collection fields within the first form;
determining that the second plurality of data collection fields includes a first data collection field that is not included in the first plurality of data collection fields; and
modifying the data collection interface to add a first interface element that is configured to accept first user input corresponding to the first data collection field.

19. The system of claim 18, further comprising:
detecting a third form that is not that is an updated version of previously detected forms;
generating a second data collection interface based on the third form at least by:
determining that the third form is of a new type that does not correspond to the previously detected forms;
identifying a third plurality of data collection fields within the third form;
creating a second plurality of interface elements configured for accepting user input corresponding to the third plurality of data collection fields; and
producing the second data collection interface using the second plurality of interface elements.

20. The system of claim 18, wherein detecting the second form that is the updated version of the first form comprises:
identifying a plurality of candidate forms that may include the updated version of the first form, the plurality of candidate forms comprising the second form; and
comparing first metadata associated with each of the candidate forms to second metadata associated with the first form to determine that the second form meets one or more form match criteria in relation to the first form.
